(19) United States
(12) Patent Application Publication
(10) Pub. No.: US 2011/0127214 A1
(43) Pub. Date: Jun. 2, 2011

(54) ENERGY OPTIMIZATION IN AN ANAEROBIC, FACULTATIVE, ANOXIC AEROBIC PLANT, USING FINE BUBBLES, WITHOUT SLUDGE PRODUCTION

(76) Inventor: Mauricio Rico Martínez, Celaya (MX)

(21) Appl. No.: 12/867,755

(22) PCT Filed: Feb. 4, 2009
(86) PCT No.: PCT/MX09/00012

§ 371 Date: Feb. 11, 2011

(30) Foreign Application Priority Data
Feb. 15, 2008 (MX) MX/A/2008/002240

(51) Int. Cl. C02F 3/30

(52) U.S. Cl. 210/605; 210/142; 210/139; 210/630

(57) ABSTRACT

System for treating waste water with intermittent aeration and low energy consumption, which comprises: a pump sump or a sump controlled by a PLC in order to achieve control of pumping, level and flow of liquid; the liquid is pumped to the aerobic treatment device or to the UASB device, which aerobic treatment comprises an air diffusion unit or fine-bubble diffusers (1) operating intermittently and diagonally, there being a high density of diffusers in the aerobic zone, where it would be an option for said region to be deeper than the other zones, an agitator (8), not only the agitator but also the blower being controlled on the basis of time using a PLC, the agitator then operating after the diffusers have stopped, and also energy is applied to prevent sedimentation of sludges inside the aeration tank. Next, the water passes to a sedimentation tank (3) which separates the liquid from the sludge and conveys the excess sludge to the UASB anaerobic sludge digestion device, using a further electrovalve (10); the UASB has a chamber for the accumulation of biogas, which may be burnt off, the burning system being controlled by the PLC, and in said part there is also a sedimentation unit that separates the anaerobic sludges from the liquid obtained. The sludge-free liquid is separated by the sedimentation unit (3), said sedimentation unit having, in the upper part, a channel with scum screens, which enables said liquid to be scum-free and sludge-free, and same is transferred to a disinfection chamber (15) designed to offer the disinfectant a residence time, the disinfectant being provided by means of a metering pump and controlled by means of the PLC, and there may optionally be a transducer for controlling the disinfectant concentration.

### PRIOR ART

This type of treatment plant is a combination of the European fine bubbling system of anoxic aerobic plants with counterflow, but with the added feature that the digestion system incorporates a system of type UASB (Up Flow Anaerobic Sludge Blanket) in the digesting of sludge, which means that there is no sludge line.

A counterflow-type aeration is used, which utilizes to the maximum the oxygen transferred to the aeration system in such a way that there is minimum energy consumption for the transfer; on the other hand, by not having digestion of sludge by aerobic means, but instead by anaerobic means, there is then discovered an anaerobic method, such as the UASB for treating sludge of an activated sludge system, of any given type, but using an anaerobic system of the UASB type as the digestion system.

This translates into a system that consumes little oxygen, since on the one hand one takes care of the mass transfer, allowing the oxygen to be transferred to the water in an efficient manner, and also in place of using [former means of]* anaerobic digestion one *Material in brackets is added for clarity.—Translator's. Note.

uses digestion by means of a UASB system, making it possible to remove very high burdens with equally high efficiency; for example, the normal efficiency of a conventional system for removal of burden in an aerobic system for sludge is close to 40 to 60%, and in a UASB system it can be higher, reaching as much as 70% or more in the removal of solids and chemical oxygen demand (COD) of the sludge.

This patent contains a treatment system based on an activated sludge plant with the modality: aerobic, anoxic, anaerobic, with low energy consumption, and without sludge production, due to the high degree of removal of the organic burden that the UASB handles in the case of the organic material of the sludge. This is a treatment plant with low energy consumption and low production of sludge, unlike other systems which produce sludge, such as those mentioned in the following patent applications or patents: CN1313250, WO2007136296, JP2007130533 and US2006000770. Other patents or patent applications use methods without production of sludge, or low production of same, MX 173685 A, MX 172965 A; however, in these cases the suspended medium is not used, as it is in this application; in the case of JP2005144291 a membrane is used, which implies a possible clogging of same, and with a substantially larger energy expense; none of the cases mentioned has the intermittent aeration system, except for JP2003245684, but this produces sludge, and it uses a membrane system that is not present in the present invention.

The system proposed in this invention additionally removes sulfur, nitrogen, phosphorus, and, of course, biological oxygen demand (BOD).

### BRIEF DESCRIPTION OF THE FIGURES

FIG. 1. Vertical section of the proposed treatment plant, seen in a side view, showing the aerobic reactor of the system (2).

FIG. 2. This figure shows the treatment plant with its pump sump and the aerobic, anoxic, optional anaerobic reactors.

FIG. 3. This figure refers to the pump sump system, showing the pumps, marine ladder (27), revealing the sand trap (19), which is much shorter than the conventional system.

FIG. 4. Plan view of pump sump containing two pumps (25) and showing plan view.

FIG. 5. Transverse section of pump sump.

FIG. 6. Front view of the spillway.

FIG. 7. Detail of attachment of the spillway to the pump sump.

FIG. 8. Another transverse sectional view of the sump, showing the Sutro [spillway] of both chambers.

FIG. 9. Another detail of fastening the gate of the sump.

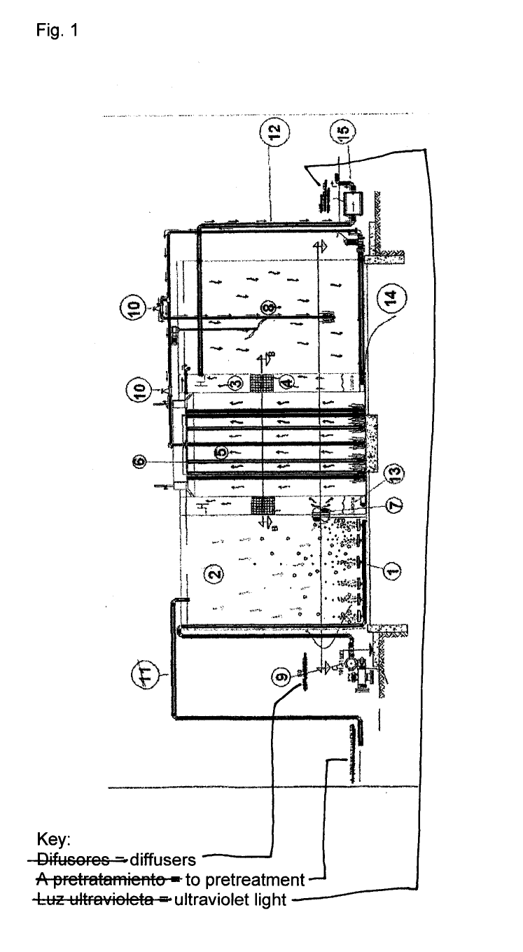

The abbreviations used in the specification and in the figures are as follows:
NTN—natural ground level
NC—crown level
NPT—finished floor level
NP—gauge level
Nhmax—maximum hydraulic level
Nhmin—minimum hydraulic level
N—hydraulic level
BOD—biological oxygen demand
COD—chemical oxygen demand

### DESCRIPTION OF THE PLANT

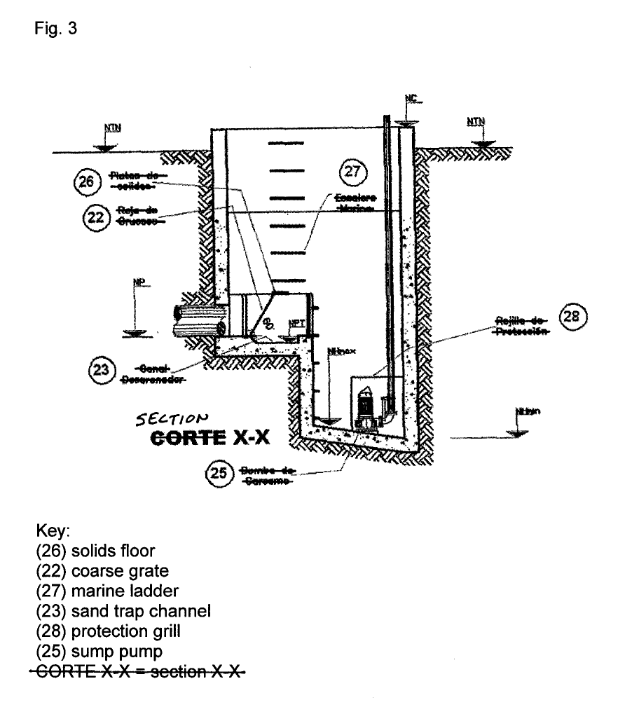

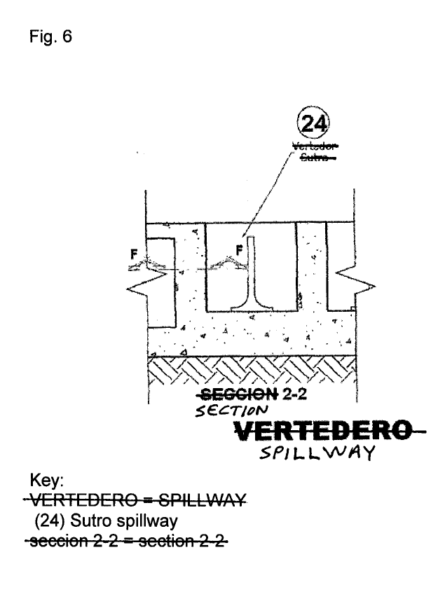

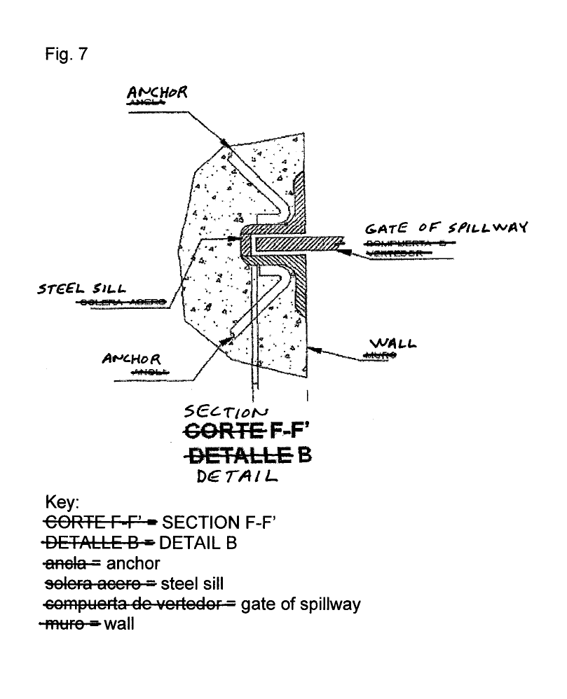

The treatment plant is made up of a pump sump (FIG. 3) and three concentric tanks, representing an aerobic tank (2), a secondary settler (20), and an anaerobic digester (21), the last tank concentric.

Which means in overall layout the following scheme which allows one to create a treatment system that makes it possible to obtain wastewater complying with the current standard containing less than 20 mg per liter of BOD (biological oxygen demand) and less than 5 mg per liter of nitrogen in all its forms, with less than 100 fecal coliform units, depending on the type of disinfectant to be used, and even obtaining lower values of BOD and fecal coliform, as well as lower nitrogen values than those mentioned above.

The treatment plant consists of the following elements:
a) Pump sump (18).
b) First aeration tank (2).
c) Second settling tank (20).
d) Third digestion tank (21).
e) Disinfecting system in the form of a disinfecting chamber or coil (15).

Pump sump.

The pump sump, shown in FIG. 3, is composed of the following elements which are fabricated to favor the injection of certain volatile suspended solids, but not the entrance of rocks, and sand, which would stay inside the sand trap chambers (23), which are very short or shorter than in conventional chambers, to allow the entrance of a certain type of sandstone, with diameter less than 0.2 cm, with specific gravity at least above one, which will allow the formation of nuclei for the formation of flakes within the aeration process, as well as within the anaerobic process.

If the sand trap system were so efficient that it eliminated all sandstone, preventing the formation of nuclei within the aerobic or anaerobic system, one would have to add to the system a medium to form nuclei of flakes within the aerobic system.

The sump is composed of the following elements:
a) Handling yard (29).
b) Sand trap chamber (22).
c) Pump sump (18).
d) Sutro meter or Sutro spillway (24).
e) Coarse matter grill (22).
f) Grating for protection of sump pumps (28).

These elements do not correspond to the traditional calculation method, but are designed to prevent deterioration of the pump by eliminating the great bulk of abrasive sand within the sand trap chamber system, and avoiding the entrance of floating matter; even so, hair and certain other elements can get through and may stop the pump. Once every six months it is necessary to conduct a cleaning, but only if clogging with garbage from the gutter occurs; if the users are habituated to not throw garbage in the drainage system, no cleaning is required. The cleaning necessary in this system is carried out once a week, or if there is a lot of garbage once every three days. In normal situations, the system is cleaned once every two weeks.

First aeration tank.

One can distinguish two forms of operation; the first is an operation with low organic burdens, with BOD between 70 and 300 mg per liter, in which the water enters directly into the aeration tank, or first aeration tank (2); when the water contains more than 300 mg per liter up to approximately 1000 mg per liter of BOD, the unit for rough processing or decreasing the amount of organic material will be the UASB, achieving up to 70% removal of organic matter.

In the first tank, dissolved oxygen is transferred by means of the blower (9) and the diffusers (1) to the domestic waste water, achieving concentrations above the saturation point, this being accomplished, depending on the altitude above sea level and the temperature of the water, in a time of around 12 minutes; after this time, the system, by means of a PLC and its software, which operates the entire system, sends the signal for the blower to stop working and at the same time the agitator (8) is operated, producing flakes within the aerobic reactor, and after consuming the oxygen within the water, the nitrates which have formed within the water by oxidation of the ammoniacal nitrogen are consumed; however, the bacterial system is supported beyond this absence of nitrates, nitrites, and oxygen, even above these values, enabling a facultative system, in which the microorganisms continue to live despite the fact that there are no nitrates, nitrites or even oxygen dissolved in the water; this implies either a micro-aerophilic or a frankly facultative phase, since the breakdown of the organic matter or the reduction of the BOD within the effluent continues; however, there are higher degrees of oxygen absence after 80 minutes, which can cause cell death with tissue necrosis, indicated by the presence of cadaverin and putrecin when the water remains in this regimen for periods of more than 5 days.

However, if the pond is very large, both the blower (9) and the agitator (8) could work at the same time, only making sure that the G gradient or dissipated energy is less than 60 per second; if said gradient is larger it will be necessary that the blower does not work jointly with the agitator, since this might damage the blades of the agitator screw, and it is preferable to halt the agitation by means of diffusers, and allow the agitator to run; this enables the formation of flakes, and prevents the biomass from settling; if settling occurs, two layers will be formed, the first of which will be an aerobic layer, and the second anaerobic, since there will be no access in this layer to oxygen, for the substrate (in this case, the organic matter), nitrates, nitrites; this means that if this sludge should die, these microorganisms will be transformed into organic matter, so that the effectiveness of removal of organic matter will be lost, since it is not possible to make contact with the substrate.

The speed of the agitator (8) should be such as to allow a speed of approximately 0.7 meters per second, up to 2 meters per second, with gradient of less than 60 seconds to the least one*. *at least one: It is unclear what is meant here.—Translator's note.

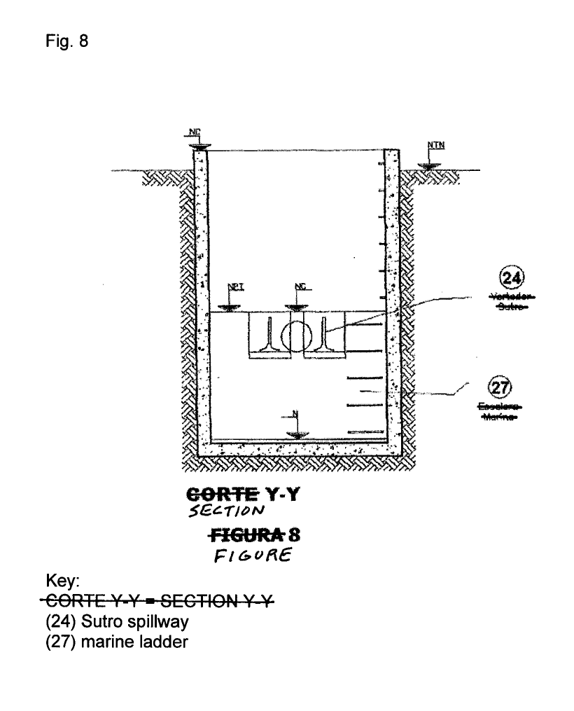

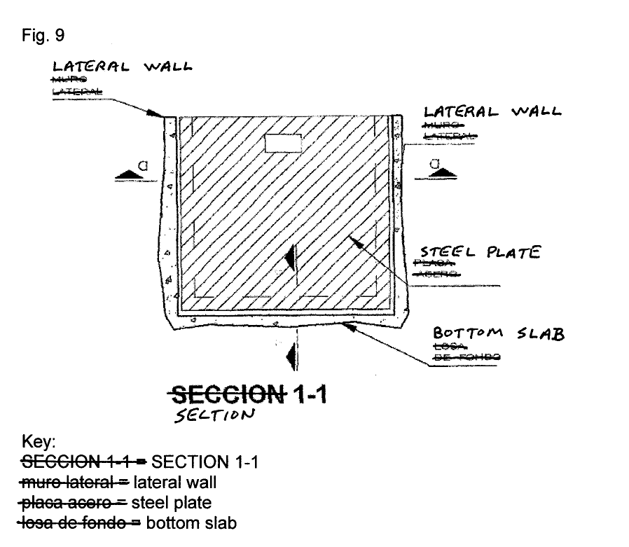

The equipment may have differences with regard to the sump pump (18), such as: centrifuges, of progressive cavity, of the Archimedes screw type, lobular and diaphragm. The screens (22) could be manual or automatic. The flow control devices can be: Sutro spillway (FIG. 8), a rotary type unit, a system of metering and control using ultrasound, ultraviolet light, mechanical, Palmer Boulus or Cipoleti type spillway. The valves can be: ball valve, gate valve, electric valve, copper retention valve, check-type valve. The control system can be: by means of a PLC or an electronic control card, or an electronic timer system. As for the aeration, its diagonal aeration diffusion system can be: by means of diffusers (1) of the fine bubble plate type, a clog-free, tubular type with clog-free fine bubbling, a ceramic plate and fine bubbling, a plastic-covered plate to prevent clogging, diffusion of air by means of a Venturi-type device, using a mechanical aeration type system eliminating the blowers, but replacing them with this type of mechanical aerators. And the blowers (9) can be: lobular or centrifugal type, with or without frequency variator to change the air flow rate. And the agitator (8) can be: high speed, with fins of less than 1 meter and speeds of 1000 to 3000 rpm, or low speed, including agitators with broad fins of more than 2 meters length each, with speeds ranging from 10 rpm to 50 rpm. Finally, the settling tank can be: with parallel sheets, modules, or of industrial type containing tube plates, or corrugated sheets, or also using settlers without sheets.

Explanation of the efficiency improvement relating to the ratio of energy to organic matter removed.

The programming of the system succeeds in making the transfer more efficient, and it all has to do with the way the cycles are programmed.

As mentioned above, the aeration of this tank is achieved by means of cycles, and each cycle has two phases, namely:

Aerobic phase.

Anoxic phase and

Facultative phase.

In the first phase, one achieves the formation of nitrates and nitrites by the addition of oxygen, as well as by the consumption of alkalinity, and also by the formation of nitrites and a modification of pH.

Also, obviously, one obtains a removal by the form of operation; nearly all treatment plants for waste water utilize the operation in the stationary microbial growth phase, which means that the quantity of sludge existing inside the reactor will be very close to 900 mL per liter of water; however, in this type of plant, it is convenient to operate in the logarithmic growth phase, which has various implications with respect to the traditional growth method:

1. A smaller quantity of active sludge inside the reactor.

2. A larger quantity of sludge purged from the UASB digester reactor.

3. Less energy consumption.

A smaller quantity of sludge inside the aerobic reactor.

Normally, the traditional operation of a treatment system involves having the organic matter as the limiting substrate, operating with high concentrations of sludge inside the reactor, taking into account that said sludge will be in a range of around 900 mL/liter; this implies that the microorganisms need to use one part of the organic matter to generate energy, and another part of the organic matter to form active biomass, and there are very high cellular replication times of more than one hour, which means decreasing the formation of sludge, and in turn cellular retention times of around 8 to 12 days; however, in this case, it is preferable to have a small quantity of cells inside the aerobic reactor, and to modify the tissue such that it is a mixture of anoxic bacteria, aerobic bacteria resistant to the lack of oxygen, and facultative bacteria, which means cellular retention times that can be close to those mentioned above, but it would also imply that inside the reactor the content of cells would be much lower, which means that the quantity of cells inside the reactor would be around at least 300 mL per liter, and it could also reach to 850 mL, versus nearly 900 mL per liter as is normally considered inside a treatment system.

A larger quantity of sludge purged from the UASB digester reactor.

To have the experience of operating in the logarithmic growth phase is to make the cells have a greater energy consumption than they would normally have to duplicate themselves, producing a larger quantity of cells; this means a greater energy consumption to accomplish the purging of these cells, but it also means that said cells inside the UASB reactor are obtained by a greater removal of organic matter since, without the intervention of energy, one achieves removals of organic matter up to 70%, without the intervention of energy consumption.

Less energy consumption due to operation near the logarithmic phase.

Every cell utilizes the energy extracted from organic matter in two possible forms:

Maintenance of the cell itself.

Replication of the cell.

The utilization of energy is preferably to maintain the cell; only when energy is in excess does the cell replicate, utilizing this energy for the formation of another new cell; however, instead of bringing these cells to endogenous metabolism, the extra cells formed are taken to the anaerobic digester, the result being less energy consumption, since the energy utilized in the formation of new cells translates into a greater efficiency of the system. One achieves an average cost of 12 cents for the energy cost, but optimization can be conducted to reduce the cost.

Consumption of alkalinity.

Alkalinity is consumed for the production of nitrates, with a total consumption of alkalinity of up to 7.14 mg of CaCO₃/mg of oxidized 1N NH₄, which means that it will be necessary to add sodium bicarbonate to the water as an aid in the nitrification and denitrification; it is important to perform the corresponding analysis for this operation, in addition to considering a dispensing unit, which is not shown in the drawings; but if the alkalinity is very small (less than 50 parts per million), it will be necessary to take precautions in adding it to the water. The dispensing zone would be at the entrance to the sump.

A lower energy consumption due to an increase in the rate of transfer by conducting the air diffusion operations in intermittent manner, also using fine bubble diffusers, and [placing] these at high density inside the aerobic region.

In principle, there exists a physical phenomenon in which the following occurs: the rate of transfer of the oxygen to the water is directly proportional to the difference between the saturation level and the initial concentration when the water transfer begins, that is:

1. If the difference in the water is greater, the rate of transfer will be higher.

R=Kla (Soₛₐₜ−So).

R=Rate of transfer of oxygen in the water.

Kla=Transfer constant through the bubble area.

Soₛₐₜ=Saturation concentration of the water in the reactor.

So=Concentration of oxygen in the reactor.

2. To accomplish the highest transfer rate, the starting concentration So will have to be as close to zero as possible, but this will affect the bacterial system, since it will generate a series of micro-aerophilic bacteria, or clearly facultative bacteria. But this system operates as follows: in the beginning, the nitrates of the water will be used up, and then the bacteria will have a facultative phase.

This means that the system of aerobic-type bacteria will have a facultative phase, in which the oxygen in the reactor will have to be zero, but even so the decaying of the organic matter will continue. It is convenient for the safety factor to be 1.5 within the system.

3. This also means that the system, upon using up the oxygen, will have very substantial oxygen variations and the bacterial system would also have to be subjected to a sequence that is different from the aerobic process in conventional activated sludge.

4. Various methods have been proposed to try to find the minimum aeration, and after the rest value or anoxic and facultative phase, making use of redox transducers, dissolved oxygen meters, and meters for the ammonia ion and nitrate; however, the best method is to do this in the field, making sure that the system does not have microbial death; with the greatest quantity of heat in the water, this can improve the bacterial growth by increasing to the maximum the oxygen consumption with the greatest quantity of removal of organic matter. However, the investigations carried out show that the removal of organic matter even in conditions of zero nitrates, and zero dissolved oxygen, which suggests a facultative phase that is not strict, and the use of transducers to measure the oxygen dissolved in water as well as the redox potential in the water is obsolete. In conditions of heat, with water temperature around 30 degrees Centigrade, the value of the aeration with fine bubbles was 9 to 12 minutes for seventy minutes of rest with agitation.

The standard value for operating these tanks is 30 minutes of rest, with 30 minutes of fine bubble aeration, wherein for almost 20 minutes the oxygen and nitrates values are equal to zero, which means a facultative phase inside the system.

5. The rest time is convenient for two reasons, the first has to do with the decrease in energy consumption, since the bacterial mass in this type of system continues functioning without consuming energy, but keeps removing the organic matter, the nitrates, nitrites, hydrogen sulfide and phosphates; the other reason is that the culture obtained with the rest times is a bacterial culture that can remain for up to 5 days without aeration, without producing odors; on the other hand, odors are produced in the bacterial cultures of conventional systems, since the bacteria upon dying produce cadaver alkaloids, such as putrecin and cadaverin.

6. Every rest period should include an agitation system that can be of the high-speed type with small paddle, or of the low-speed type with large paddle; in the first case, one can allow a speed of up to 1750 rpm, but the power input would have to be up to 1 Watt per cubic meter of water treated in both cases; for small systems (less than 45 liters per second), the high-speed system is preferable, due to its low cost, and in the case of large systems (more than 45 liters per second) the low-speed system is preferable, with paddle speed of 18 to 22 rpm. In any case, it is important to check the gradient, and in both cases the gradient, expressed as s⁻¹, should not exceed 60 s⁻¹; if it is not, it is advisable to correct said gradient by lowering it, and leave it at values less than this 60 s⁻¹.

In this first tank, the ammoniacal nitrogen is transformed first into nitrates and nitrites, as is observed in the following stoichiometric equations.

Formation of nitrites.

[Proceed] in such a way that the following reaction takes place:

2NH₃+7/2O₂=3H₂O+2NO₂⁻

Formation of nitrates,

2NH₃+3O₂=3H₂O+NO₃⁻

The first aeration tank (2) is a dual-purpose aeration system, since there is an aerobic system and an anoxic system, in which, at the time of carrying out the nitrification the ammonia is transformed into nitrates and nitrites; and when reacting with hydrogen sulfide, the nitrates are transformed into elemental sulfur, water, and atmospheric nitrogen.

NO₃+3H₂S=N₂+3S+3H₂O

This makes the odor diminish significantly in the aeration system, which inhibits the odor produced from the hydrogen sulfide.

This process of removal of hydrogen sulfide, besides permitting a substantial removal of sulfur in the water, makes sure that odors of hydrogen sulfide are not present, since the primary component of the odor of a treatment plant is due to the presence of hydrogen sulfide, and thanks to having a phase which allows the nitrates to function by eliminating this hydrogen sulfide, the plant has little or no odor; the other possible source of odor is that of allowing the biomass to die, for a very prolonged period of rest with agitation, which induces certain microorganisms that are in latency because they are not strict facultative types to die and thus produce an odor different from the cadaverin and putrecin type. But furthermore, some energy is obtained that would not have been considered: by transforming the ammoniacal nitrogen into nitrites and nitrates, the energy that is furnished in their production and would not previously have been recovered is recovered and reutilized to diminish the odor of the system; this is one of the reasons why the plants do not have an odor, or are safer than the aerobic system; on the other hand, when the aeration system stops, the culture is in a facultative culture form, which uses hardly any oxygen and continues consuming BOD and organic matter in the waste water, and so it does not use energy in the system.

That is, besides removing the organic matter, the nitrogen and the sulfur are removed in the treatment system.

In other words, one can guarantee the best water with a treatment system of low energy cost.

[This system] removes not only the organic matter but also the nitrogen, phosphorus, sulfur, the four most important members of the system polluting waste waters, at no additional cost.

Also inside this tank there is a system of flocculation by means of agitation of a floor agitator, which brings about a formation of flakes inside the system, allowing for a better settling in the following tank; this is brought about by decreasing the gradient, down to values very close to 60 seconds at least one*, which implies the formation of flakes, and also the presence of a better removal as well as the formation of a facultative cycle, this removes organic matter without the intervention of energy. *at least one: It is unclear what is meant here—Translator's note.

Besides the above-given reasons, there are other reasons which imply less energy consumption for transfer, which would be:

The existence of a facultative phase after the anoxic phase.

What are the reasons expressed above, as to why an anoxic phase and a facultative one exist in the rest phase, in which the removal of organic matter continues, without the presence of oxygen, or the existence of nitrites or nitrates?

An oxic or aerobic reactor with high concentrations of diffusers in the oxic or aerobic region.

There also exists an oxic, or aerobic system (16) in the aeration system; this is in addition to the existence of a zone of high concentration of diffusers inside one part of the aerated tank.

This aerobic reactor allows an increase in the level of transfer of oxygen to the water in the tank.

Bubble exit in hypotenuse form.

A greater contact of the bubble with the water provides a greater transfer of oxygen in the water; achieving an agitation in diagonal form implies a greater contact of the bubble with the water, which improves the efficiency of transfer of oxygen to the water, as it exhibits greater contact of the bubble with the liquid, and this, of course, improves the transfer.

Optimal programming of the aeration tank.

As a result of this, to optimize or decrease the aeration time, it would be advisable for the system to be optimized; this would be achieved by operating the treatment plant during the hotter months, then making sure that the water present has the maximum consumption of oxygen on the part of the bacteria, gradually decreasing the aeration time and increasing the rest time, likewise in gradual fashion.

[During] optimal aeration periods, the aeration would be such as to provide minimum aeration times in order to decrease the energy consumption, giving as a result the following Table 1.

TABLE 1
Minimum and maximum parameters of the phases in a cycle.

| | Minimum time, | Maximum time, |
|---|---|---|
| Parameter | minutes per cycle | minutes per cycle |
| Aeration time | 9 | Total aeration |
| Rest time or agitation | Total aeration | 80 |
| with floor agitator | | |

Second tank or settling tank.

With the flake formed by the floor agitator (8), the flake is precipitated in the second internal tank (20), which has parallel sheets (4) in its middle part, here in this settler along with the sheets, possible hydraulic loads of up to 120 m³/m² per day, but it is possible not to have sheets, but this would mean using hydraulic loads of less than 20 m³/m² per day. The second tank of the system is a settling tank, which for reasons of footprint should be of the sheet type, which can have higher rates of sedimentation than conventional tanks, and it enables normal precipitation of the water without the need for flocculants or other reagents; it is known that the activated sludge of an anoxic process is hard to precipitate, but in a system of parallel sheets it may be better to use a conventional or low-rate settler.

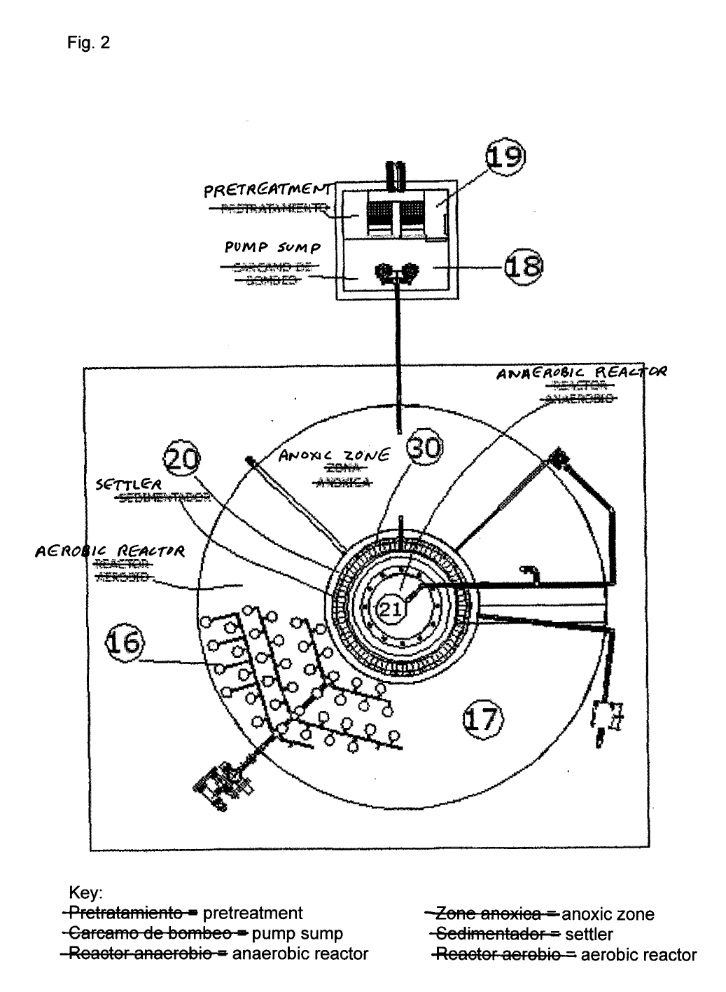

The sedimentation system has a ring (30), formed by a hose of high-density polyethylene, or any other flexible material that can be molded into a hollow cylinder, which has the task of collecting the sludge formed in the system, in the sludge zone (13), and this ring makes it possible to bring the sludge to a pump with a dry sump (14), which conveys it and returns part to the aerobic tank, by means of electrical restriction valves, and also the excess is purged by means of certain electric valves (10) to the UASB reactor (21), which is the third tank or the innermost tank in FIG. 2, whose task is to convey it to the first aerobic tank that is optimized in accordance with the needs of each treatment plant.

Third tank of anaerobic digestion or UASB.

The third digestion tank, shown in FIG. 2, is implemented by means of a system of the UASB type; the sludge is transported by the sludge recycling pump (14) and drained from the second tank, and, by means of the electric valve, it is poured into the UASB-type anaerobic tank; in order to maintain the quantity of sludge in the system, the cellular retention times are shorter; this permits one to expect more aerobic purge sludge, but the efficiency of anaerobic digestion is close to 90%, so a different biomass than the conventional one is also expected in a system of activated sludge.

The efficiency of the anaerobic sludge digester by means of UASB is around 90%; this enables a sludge production of almost zero, inasmuch as the production of sludge at the end of nearly 4 years is zero, and the parameters for perparing sludge are different from the conventional ones. With the conventional systems, one would need to have a production a thousand times larger, with an average production of 1 liter per second of nearly a total of 200 liters a day, at 60% moisture content, versus nearly zero in the same time frame. In other words, it can be said that this system does NOT produce sludge of the biological type in the process proposed here, or its production is very small, virtually zero for practical purposes.

The UASB system used is designed to have a high removal with mass of the flocculating type; however, one could have pellets or bacteria of the granular type, preferably those of the flocculating type.

For this case, the ecosystem found in the treatment plant of the slaughterhouse of Salamanca, Guanajuato, Mexico, is the alternative for being able to seed other reactors using the ecosystem existing there.

After the sludge is digested by the UASB, the liquid produced from the digestion will end up at the first tank or the aerobic tank, containing a considerable concentration of BOD₅, but in the end it can be absorbed by the aerobic process; this concentration should be taken into account when calculating the input concentration, but for practical purposes it implies an increase of up to 20% in the input BOD₅ concentration, which means that a very slight energy increase might be necessary, but since the system is so efficient this increase for treating this leachate from anaerobic bacteria is [practically] zero.

The UASB system will continue to operate, accumulating fixed suspended solids (FSS) in the system, since these will have a tendency to form flakes inside the the UASB reactor unit, but also when there are many flakes, they will have a tendency to reduce the hydraulic residence time, and also they will prevent the formation of volatile suspended solids (VSS), which adversely affects the operation, since they form the active biomass, or the microorganisms whose task is to biodegrade the organic matter.

The operating ratio of volatile suspended solids (VSS) to total suspended solids (TSS) will be:

VSS/TSS in theory; if there is very good sludge, this coefficient would be equal to one, and this would mean that the fixed suspended solids are zero; but in practice this coefficient is 0.2 to 0.4.

A value of less than 0.1 might mean that it is necessary to purge the reactor, so that it would be necessary to remove the existing sludge; it is calculated that a total of approximately 3 cubic meters would be formed every 7 years.

If one wishes to diminish the concentration quantity of BOD₅, the first tank would be the UASB digester tank, which would have two functions: rough treatment and digesting of sludge; but when the burden is greater than 400 mg per liter, the rough treatment tank would be solely for digesting of sludge.

There are two forms of operation in this process:

Operation with low burden.

Operation by the introduction of waste water influent, with concentrations below 300 mg per liter, directly in the aerobic system.

When applicable, this UASB is designed to operate with hydraulic residence times of up to 1 day or more, using as the calculation basis the quantity of sludge produced and its concentration in the aerobic system.

Operation with high burden.

Operation with influent of over 300 mg per liter to below 10,000 mg per liter, where first one would use the UASB as a rough treatment unit, achieving efficiencies of up to 70%, based on BOD measured at five days, with retention times of up to 12 hours in the initial UASB system, but using as the calculation basis the entrance flow rate or design flow rate.

In this case, in addition to the rough treatment unit, the UASB unit would be a sludge digesting unit.

Disinfecting system or disinfecting chamber.

The disinfecting system is by means of chlorine isocyanate, or by means of ultraviolet light or by the use of ozone, which is able to remove the organic matter, but not the microorganisms, so that the following methods of disinfecting are used:

Photodisinfecting by means of photodyes.

Using para-rosasiline* and/methylene blue. *sic; para-rosaniline?—Translator's note.

The photodisinfecting would be a reactor agitated with atanase**, which is the allotropic form of titanium dioxide, which, when assisted by ultraviolet light, can form high-energy electrons, able to break organic chains as well as rings; concentrations of up to 20 ml per liter of atanase**, with illumination of up to 100 W per cubic meter, can be useful in achieving a clear effluent with no organics; this method can decrease the content of TOC (total organic carbon), along with color, and also fecal coliform count. **sic; anatase?—Translator's note.

Use of ozone.

The use of ozone may be helpful if one uses up to 30 mg per liter of ozone to oxidize and disinfect the effluent, accomplishing a disinfecting in chambers of less than 1 minute; the application of ozone in these concentrations may leave the effluent with colors of less than 20 units on the Co—Pt scale and concentrations of fecal coliform count of less than 100 NMP/100 ml.

Use of chlorine for disinfecting, or some other halogen compound, such as bromine, chlorine or iodine.

Having a residual chlorine concentration from 0.2 mg per liter to 1 mg per liter, with residence times up to 20 minutes, residual bromine and iodine with the same dosage and retention time of up to 20 minutes, preferably using chlorine isocyanate, and hypochlorite formed “in situ”, as the organic color of the water is consumed.

Use of silver, copper, zinc ions.

Startup of the system.

For the “startup” of the system, it is necessary for biomass to be present, so that there are two possible options:
Formation of biomass from the waste water itself (preferred method).
Startup without formation of biomass.

With formation of biomass from the same waste water.

The preferred method for the startup is to produce the suspended tissue, using for this an addition of commercial sugar, 1.5 grams of commercial sugar for each thousand liters, every 3 hours to establish the sludge, with agitation every 30 minutes with rests of 30 minutes. This routine lets one form the facultative tissue without formation of odors, or the presence of bulking (sludge bulking), which does not settle when it has low density.

But if the odor is not important, one can increase the agitation for a longer time, for example, agitation for 60 minutes with rest of at least 30 minutes, which would imply a more rapid formation of biomass; one way of increasing the larger quantity of biomass in the aerobic system is to prevent oxygen shutdowns, enabling a large quantity of this biomass to be formed, allowing a type of Pasteur effect to be present, since a more aerobic system produces more biomass in the waste water; one could even allow a system supersaturated in oxygen so that biomass is formed, with the presence of sugar or any other soluble sugar, whether triose, tetrose, pentose, hexose, preferring the cheapest one, possibly a hexose (glucose, fructose, etc.), or for lack thereof a polysaccharide, or a disaccharide, such as commercial sugar.

Startup without formation of biomass “in situ”.

Use of activated sludge from any treatment plant can be conditioned for this type of plant if one first allows periods of rest, in which the anoxic and facultative bacteria can be formed, without this causing a bulking or flotation in the secondary settler.

This is achieved by allowing intervals of rest time, with floor agitation, ranging from ten minutes to one day, increasing every day by one minute, until reaching the standard value, or operating value, which could be as low as 12 minutes of aeration, with approximately 70 minutes of rest with agitation.

1. A system for treatment of waste waters with intermittent aeration and low energy consumption, comprising: a pretreatment device for waste water, which includes pumps that suck in the waste water, which has been screened through a fine and coarse grill, the gravel being stored in a chamber; said pretreatment device has a flow metering and control device, retention and control valves, these pumps are controlled by means of electrical controls, which send the signal to a PLC device to provide the control of pumping, level, and flow rate of liquid; the liquid is pumped to the treatment device, or to the UASB device, which is the sludge digester; the aerobic treatment device that is composed of an air diffusion unit or fine bubble diffusers, which are fed by a blower which blows air to them and operates intermittently and diagonally, there being a high density of diffusers in the aerobic zone, where said region, as an option, could be deeper than the other zones; an agitator, both the agitator and the blower being controlled in time using a PLC, the agitator operating after the diffusers have been halted, and additionally energy being applied to prevent the sedimentation of sludge inside the aeration tank.
The water then goes to a settling tank, which separates the liquid from the sludge, this being accomplished by means of a chamber that stores the sludge inside this settling device; for the purpose of achieving a more homogeneous sludge suction, in the lower part of this sedimentation chamber there is a ring which serves to suck in the sludge by means of a pump, said pump having the characteristic of being designed to
prevent excessive pressure; by means of certain pipelines, the pump transfers the sludge to the treatment equipment, using an electric valve, and it sends the excess sludge to the anaerobic sludge digesting device, using another electric valve; said [digesting] device of type UASB (Up Flow Anaerobic Sludge Blanket) digests the sludge by means of anaerobic bacteria, not using energy for the digestion, and forming a blanket of flocculent or granular sludge; this UASB device is composed of inlet pipes, to force the sludge to enter, and it travels from bottom to top using a pipeline; in the upper part there is a biogas accumulation chamber, and the gas can be burned off as it rises, to prevent harm to the atmosphere; the burning system is controlled by the PLC, and in this part there is also a settling unit that separates the anaerobic sludge from the liquid obtained*.
*at least one: It is unclear what is meant here.—Translator's note.
The liquid without sludge is separated by the settler, said settler in the upper part having a channel and a sawtooth spillway with scum screens, so that this liquid contains neither scum nor sludge, and it is transferred to a serpentine disinfecting pipe or chamber, whose task is to give the disinfectant a residence time; the disinfectant is provided by a dispensing pump, and controlled by means of the PLC; optionally there can be a transducer to control the concentration of disinfectant.

2. The system for treatment of waste waters with intermittent aeration and low energy consumption, as is claimed in 1, whose sump pumps can be: centrifuge pumps, progressive-cavity pumps, Archimedes screw-type pumps, lobular and diaphragm pumps.

3. The system for treatment of waste waters with intermittent aeration and low energy consumption, as is claimed in 1, whose screens can be: manual or automatic.

4. The system for treatment of waste waters with intermittent aeration and low energy consumption, as is claimed in 1, whose flow control and metering device can be: a Sutro spillway, a rotary-type unit, a system of metering and control using ultrasound, ultraviolet light, mechanical, Palmer Boulus or Cipoleti-type spillway.

5. The system for treatment of waste waters with intermittent aeration and low energy consumption, as is claimed in 1, whose valves can be: ball valves, gate valves, electric valves, copper retention valves, and valves of the check type.

6. The system for treatment of waste waters with intermittent aeration and low energy consumption, as is claimed in 1, whose control system can be: by means of a PLC or by means of an electronic control card, or by means of an electronic timer system.

7. The system for treatment of waste waters with intermittent aeration and low energy consumption, as is claimed in 1, whose diagonal aeration diffusion system can be: by means of diffusers of the fine-bubble, clog-free, plate type; tubular type with clog-free fine bubbling; ceramic plate and fine bubbling; plastic-covered plate to prevent clogging; diffusion of air by means of a Venturi-type device; by means of a mechanical aeration-type system eliminating the blowers, but replacing them with this type of mechanical aerators.

8. The system for treatment of waste waters with intermittent aeration and low energy consumption, as is claimed in 1, whose blowers can be: lobular or centrifugal type, with or without frequency variator to change the air flow rate.

9. The system for treatment of waste waters with intermittent aeration and low energy consumption, as is claimed in 1, whose agitator can be: high speed, with fins of less than 1 meter and speeds of 1000 to 3000 rpm, or low speed, including agitators with broad fins of more than 2 meters length each, with speeds ranging from 10 rpm to 50 rpm.

10. The system for treatment of waste waters with intermittent aeration and low energy consumption, as is claimed in 1, whose settling tank can be: of parallel sheets, of modules of the industrial type containing tube plates, or corrugated sheets, or also using settlers without sheets.

11. A method for the treatment of waste waters with intermittent aeration and low energy consumption, comprising the following stages:
a) Pretreatment as a process designed to remove sand of 0.2 cm, but leaving behind the smaller sand that can pass through, removing all the non-biodegradable particles, and then inside the pump sump the ideal residence time would be less than or equal to 20 minutes.
b) The water is pumped to a water treatment device, said treatment is variable, depending on:
If the BOD concentration measured at five days is between 300 and less than 1000, the treatment is of three phases: aerobic, anoxic and facultative; the aerobic phase has hydraulic residence times of 4 hours to 3 days, the anoxic phase, which is a function of the nitrogen content in the particular waste water, but which is calculated on the basis of a safety factor of 1.5 to 2.5 times the theoretical time, said time could be 3 hours in addition, up to more than 3 days.
If the BOD concentration measured at five days is greater than 300 but less than 10,000, the system includes a fourth phase, which is the initial anaerobic phase, which means the system is started from the UASB as the first unit after the pump sump, with residence time of up to 24 hours, or up to 5 days. Under these conditions, the UASB system has a dual function, one as rough treatment unit and another as a sludge digestion system; subsequently, the sludge is transferred to a unit of UASB type, in the case of low burden, where the sludge is digested, with efficiencies ranging up to 90% of the volatile suspended solids; the remaining liquid is returned to the aeration system. In the UASB system, the organic sludge is gradually replaced by fixed suspended solids, which will need to be purged approximately every 7 years, or when the VSS/TSS factor is less than 0.1. The treated liquid is settled out with retention times of 10 minutes to 2 hours, the purging time by the pump inside the settling chamber being no more than 4 hours. The purge volume varies according to the BOD content of the influent, the purge being conducted in such a way as to place the bacterial mass in a logarithmic growth phase and not in a stationary growth phase, as is generally done, but it must ensure that the purge time for the content of sludge in the system is on the order of at least 5 mL per liter, as
measured in the Imhoff cone, up to 900 mL per liter, taking into account that low sludge concentrations, and low temperatures, can cause froth, ranges of 300 to 850 mL per liter of sludge being preferable in household waste water. The purge should guarantee that the bacteria are in logarithmic phase.
c) The purge sludge or excess sludge is drained to a UASB system, which degrades the sludge in an anaerobic manner, constituting an alternate phase to the system, since it will be an anaerobic phase exclusively for the purge sludge.
d) After this, the effluent is disinfected with times varying from less than 1 minute in the case of ozone to 30 minutes in the case of chlorine.

12. The method for the treatment of waste waters with intermittent aeration and low energy consumption, as is claimed in 11, which can use as the disinfectant one or mixtures of the following: silver ions, photodyes such methylene blue, para-rosaniline, bromine, iodine, copper, hydrogen peroxide, ultraviolet light combined with anatase and ultraviolet light alone.
